(19) United States
(12) Patent Application Publication
(10) Pub. No.: US 2025/0083750 A1
(43) Pub. Date: Mar. 13, 2025

(54) Connection Element for Connecting a First Tube to a Second Tube of a Cross Member, Cross Member for a Vehicle, and Method for Connecting Two Tubes of a Cross Member

(71) Applicant: Linde + Wiemann SE & Co. KG, Dillenburg (DE)

(72) Inventors: Daniela NEUL, Leun (DE); Alex ZEISER-RASUMAK, Marburg-Ockershausen (DE); Dennis FUSS, Bad Wildungen (DE)

(73) Assignee: Linde + Wiemann SE & Co. KG, Dillenburg (DE)

(21) Appl. No.: 18/728,229

(22) PCT Filed: Mar. 6, 2023
(86) PCT No.: PCT/EP2023/055545

§ 371 Date: Jul. 11, 2024

(30) Foreign Application Priority Data
Mar. 10, 2022 (DE) 10 2022 105 629.5

(51) Int. Cl. B62D 25/14; B62D 27/02

(52) U.S. Cl. CPC B62D 25/145; B62D 27/02

(57) ABSTRACT

The invention relates to a connection element (10) for connecting a first tube (1) to a second tube (2) of a crossmember (15) for a vehicle, wherein the connection element (10) has at least one longitudinal wall (5) adjoined by at least one transverse wall (6, 7) arranged preferably perpendicularly to the longitudinal wall (5). According to the invention, the at least one transverse wall (6, 7) has, on a first end (9), an edge (8) which preferably matches the circumferential contour of the first tube (1), and which, for a preferably rotatable arrangement of the connection element (10), rests on the outer circumference of the first tube (1) at least over part of the circumference, and, at a second end (11) of the longitudinal wall (5), a portion (12) is provided which is connectable, preferably weldable, to the second tube (2) in the assembly position of the connection element (10). The invention also relates to a crossmember for a vehicle and to a method for connecting two tubes of a crossmember.

### CROSS-REFERENCE TO RELATED APPLICATIONS

This application is a national stage application (under 35 USC § 371) of PCT/EP2023/055545, filed Mar. 6, 2023, which claims benefit of DE 102022105629.5, filed Mar. 10, 2022, the contents of each of which is incorporated by reference herein.

### BACKGROUND OF THE INVENTION

### Technical Field and State of the Art

The invention relates to a connecting element for joining a first tube to a second tube of a crossmember, to a crossmember for a vehicle, and to a method for joining two tubes of a crossmember.

Such a crossmember can be arranged as part of a motor vehicle body between the so-called A-pillars of the motor vehicle in the area below the windshield, extending approximately horizontally. The crossmember is generally used to fasten an instrument panel, whereby the crossmember also stiffens the instrument panel.

In addition to stiffening the instrument panel, the crossmember must have a high bending stiffness due to its function as a chassis component, which also contributes toward increased safety of the motor vehicle and toward protecting the vehicle occupants in the event of an accident.

Generic crossmembers can be made of a continuous tube. However, it is also conceivable that structural conditions dependent on the type of vehicle require constructing the crossmember from a plurality of tubes that must be permanently joined to one another. It is conceivable to produce the crossmember from a plurality of tubes having different cross-sectional sizes and/or shapes.

If the crossmember has a tube arrangement assembled from several tubes, this presents a basic problem of creating a bending-resistant joint between the individual tubes.

One way to join two tubes is to arrange the two tubes together partially overlapping next to each other such that the tubes touch in the overlap region, and to weld the two tubes together in the overlap region. However, if the two tubes have a round cross section, this presents the problem that the two tubes in the overlap area only touch along a generatrix, and the joint between the two tubes is correspondingly limited to a linear weld seam. However, such a joint between the two tubes does not have sufficient bending stiffness.

In order to achieve a higher bending stiffness with such a joining method, the overlap region could be increased in the longitudinal direction, which, however, results in higher material expense and thus in a higher weight of the tube arrangement due to the longer required length of the two tubes, which is particularly undesirable when using the tube arrangement for a crossmember in a motor vehicle.

Another possibility for joining the two tubes of the tube arrangement is to arrange a metal bracket in the overlap region of the two tubes that extends transversely to the longitudinal direction of the two tubes and is welded to both tubes, and to arrange a gusset plate that extends in the longitudinal direction of the tubes from the respective end of the one tube to the other tube. Although the gusset plates increase the bending stiffness of the joint between the two tubes, they have the disadvantage that when the tube arrangement is used for a crossmember, they interfere in the area of the joint between the two tubes with the attachment of further structural parts of the crossmember, in particular attachment elements, for example for the instrument panel. In addition, this joining method and the associated constrained position of the tubes prevents tolerance compensation.

DE 10 2018 126 040 A1 relates to a connection sleeve arrangement for joining tubular crossbeams in a vehicle, in particular to a connection sleeve arrangement for joining a first tubular crossmember to a second tubular crossmember of an instrument panel carrier in a vehicle. A connecting element adapted as a curved connecting sleeve arrangement is designed to allow a transverse offset between two crossmembers accommodated in the connecting sleeve arrangement.

A tube arrangement with a first tube and with at least one second tube is known from DE 10 2008 045 914 B4, wherein the first tube and the second tube are arranged relative to one another with an offset transverse to the longitudinal direction of the tubes and with a partial overlap region in the longitudinal direction of the tubes such that a first end of the first tube is arranged next to the second tube and a second end of the second tube is arranged next to the first tube. The tube arrangement further comprises at least one connecting element that permanently joins the first tube and the second tube to one another in the overlap region.

The disadvantage of the known connecting elements is that a joint on the end face extending transversely to the longitudinal tube direction brings the tubes into a constrained position, namely depending on the dimensionality or the distance of the cutting edges in relation to each other in the connecting element. On the other hand, the known solutions do not permit tolerance compensation of manufacturing tolerances of the tubes.

Based on the aforementioned disadvantages, the invention is based on an objective to further develop a stable and advantageously assembled connecting element for joining two tubes of a crossmember and such a crossmember of the aforementioned type such that the tube arrangement has sufficient bending stiffness in the area of the joint. Furthermore, an object of the invention is to provide an improved method for joining two tubes of a crossmember.

### SUMMARY OF THE INVENTION

A connecting element for joining a first tube to a second tube of a crossmember for a vehicle comprises at least one longitudinal wall adjoined by at least one transverse wall arranged preferably perpendicular to the longitudinal wall.

The at least one transverse wall has on a first end an edge or edge region adapted to the circumferential contour of the first tube, said edge—for a preferably rotationally movable arrangement of the connecting element—at least partially circumferentially abuts the circumference of the outer circumference of the first tube, and a section is provided on a first end of the longitudinal wall that can be, or is, joined or welded, to the second tube in the assembled position of the connecting element.

In other words, the section can be joined to the second tube at the first end of the longitudinal wall, and the connecting element can abut the first tube in the longitudinal direction in the region of a second end of the longitudinal wall, in particular with at least one transverse wall.

Herein, the term “tube” is to be understood generically, i.e., the tube can have any cross-sectional shape that can be round, angular, or oval, for example.

Furthermore, it goes without saying that as it relates to the inventive crossmember, the first tube and the second tube can have the same or different cross-sectional shapes and/or cross-sectional sizes.

Furthermore, the first tube and/or the second tube can not only have a straight projection, as seen in the longitudinal direction, but can also have one or more bends. In addition, the tubes can—instead of extending parallel in relation to each other—also extend at an angle in relation to each other.

Both tubes are spaced at a specific distance from each other. Due to the manufacturing process, this distance fluctuates in the tolerance range. In order to keep both tubes in position despite the manufacturing tolerance, the connecting element is adapted such that it can absorb this fluctuation without placing the two tubes in a constrained position.

Compared to the prior art, it is advantageous that each end face, i.e., the section of the connecting element encompassing the tube, is arranged, in particular, welded, on a single tube and not on both tubes, as in the prior art. This embodiment avoids the disadvantages shown because each part of the connecting element can first be positioned on one of the tubes and then be brought into contact by rotating it until it makes contact to the opposite tube.

Manufacturing tolerances can be compensated due to the arrangement of the first and second end face in the transverse direction of the tubes because the tubes are not brought into a constrained position, which would prevent tolerance compensation.

The so-called end face is arranged in the longitudinal tube direction and is joined to both tubes. In addition, all three edges of a gusset element or connecting element are joined to one tube only. In the prior art, however, six edges are usually joined to both tubes.

Overall, the connecting element ensures tolerance compensation in the longitudinal direction of the tubes and also with regard to the distance between the tubes.

According to a first advantageous further development of the invention, the longitudinal wall extends in the assembled position of the connecting element from the first tube to the second tube and can be joined, in particular, welded, to both tubes.

In order to maximize the strength of the joint between the two tubes, a substance-to-substance bond, in particular by welding, is necessary along all edges.

Each gusset element is joined to all three edges on only one of the tubes, and on the opposite tube with only one edge, i.e., with one weld seam.

In an advantageous further development of the invention, the at least one transverse wall and the longitudinal wall are joined, preferably welded, to one another with a substance-to-substance bond; in particular the at least one transverse wall is formed integrally with the longitudinal wall. As a result, the stability and bending stiffness are further increased, thus further improving the safety of vehicle occupants. The manufacturing process of the connecting element is also simplified, thus reducing manufacturing costs.

According to a further variant, the longitudinal wall is arranged between the first transverse wall and a second transverse wall spaced apart from the first.

The invention further provides that the first end of the transverse wall is arranged opposite to the first end of the longitudinal wall on the connecting element, i.e., said first end can be provided in the region of the second end of the longitudinal wall.

According to an advantageous further embodiment of the invention, the width of the transverse wall decreases in relation to the second end of the transverse wall opposite the edge; the width in particular tapers toward said end. In this way, the material input can be kept as low as possible, from which weight savings of the components are advantageously possible.

It is also conceivable that the longitudinal wall can be joined to one of the tubes at the first end and at a second end opposite to the first, wherein the connecting element can additionally be joined to at least one transverse wall with one of the tubes in the region of the second end of the longitudinal wall.

In a further embodiment of the invention, the connecting element comprises two sub-elements, each of which comprises a longitudinal wall and at least one transverse wall; the longitudinal wall of each sub-element is preferably arranged between the first and a second transverse wall spaced apart from the first transverse wall. The connecting element therefore comprises, or is formed by, two sub-elements. The technical advantage of a particularly durable connection of the tubes is thus achieved.

An advantageous embodiment of the invention provides that the at least one transverse wall of the first sub-element has the edge or edge area adapted to the circumferential contour of the first tube and the at least one transverse wall of the second sub-element has the edge or edge region adapted to the circumferential contour of the second tube, wherein the edges—for a preferably rotationally movable arrangement of the connecting element—at least partially circumferentially abut the outer circumference of the first or second tube.

As mentioned, the spacing of the tubes fluctuates in the tolerance range. In order to keep both tubes in position despite the manufacturing tolerance, the connecting element is adapted such that it can absorb this fluctuation without placing the two tubes in a constrained position. Each end face, i.e., the section of the connecting element encompassing the tube, is arranged on, in particular, welded to, a single tube. Each part of the connecting element is first positioned on one of the tubes and then seated by rotating it until it makes contact to the opposite tube. Manufacturing tolerances can be compensated due to the arrangement of the first and second end face in the transverse direction of the tubes.

According to an advantageous further embodiment of the invention, the first end of the longitudinal wall of the first sub-element in the assembled position of the connecting element can be, in particular, joined, preferably welded, to the second tube and the first end of the longitudinal wall of the second sub-element in the assembled position of the connecting element can be, in particular, joined, preferably welded to the first tube.

In a further advantageous variant of the invention, the longitudinal wall comprises at least one section for joining to at least one tube by which the sub-element is seated against one of the tubes in an assembled position. At the first end of the longitudinal wall, the connecting element can only be joined to the one tube by the connecting section and only be joined to the other tube at the second end with a section and to at least one transverse wall. This further increase bending stiffness. It is also conceivable that the connection section at least on one side projects relative to the at least one transverse wall of the sub-element and is in particular, adapted as a dead stop.

An advantageous embodiment of the invention provides that the connecting element is substantially made of metal or plastic.

According to a further development of the invention, at least one of the sub-elements has at least one geometric feature for increasing the bending stiffness of the connecting element, wherein the at least one geometric feature is preferably formed as a crease.

These geometric features further increase the bending stiffness, in particular

the transverse wall stiffening of the connecting element. Numerous variants for increasing the bending stiffness are conceivable for the position, the geometric design and the number of creases. It is also conceivable to provide such features on only one sub-element, or on both.

A first independent idea of the invention relates to a crossmember for a vehicle with at least one first tube and one second tube and to a connecting element for joining the first tube to the second tube, in particular to a connecting element described above.

According to a first advantageous aspect of the inventive crossmember, the connecting element comprises sub-elements that are joined, in particular, welded, together and/or wherein at least one transverse wall of the sub-elements is joined, in particular welded, to the tubes.

Another advantageous embodiment provides that in the assembled position, the longitudinal walls and two transverse walls of the two sub-elements of the connecting element form the shape of a polygonal profile, in particular a square profile or a pentagon, in a sectional plane spanning between the two tubes and parallel to the longitudinal direction of the tubes.

In this case, it is particularly advantageous that overall a slimmer design of the connecting element is ensured, which in particular has installation space advantages. Furthermore, the additional weld seams in a pentagon profile provide better lateral or cross stiffness compared to a square profile.

According to an advantageous further embodiment of the invention, the respective transverse walls of the two sub-elements are in the assembled position arranged inside each other or offset from each other. In addition, the transverse walls of the respective sub-elements can be joined, in particular, welded, to one another in the area where the sub-elements are arranged inside each another or in the area where the two sub-elements are arranged at an offset.

A particularly advantageous further embodiment of the invention provides that the first and second sub-element of the connecting element is joined, in particular, welded, to both the first tube and the second tube in a substance-to-substance bond, thus further increasing the bending stiffness of the crossmember.

According to an advantageous embodiment of the invention, the first tube and the second tube are arranged relative to one another with an offset transverse to the longitudinal direction of the tubes and in the longitudinal direction of the tubes with an overlap region extending over a partial length of the first tube and over a partial length of the second tube such that a first end of the first tube is arranged next to the second tube.

A further independent idea of the invention relates to a method for joining two tubes of a crossmember, in particular as described above for a vehicle, wherein a connecting element, in particular as described above, is placed rotationally movable on the first tube and is rotated about the first tube until a dead stop of the connecting element comes to rest on the second tube and the connecting element is permanently joined, in particular welded, to the second tube at least in the region of the dead stop.

According to an advantageous further embodiment of the invention, the connecting element is permanently joined, in particular, welded, to the first tube after it comes to rest against the dead stop on the second tube.

According to a variant of the invention, the connecting element comprises two sub-elements, wherein the first sub-element is placed rotationally movable onto the first tube and the second sub-element is placed rotationally movable onto the second tube and are rotated relative to the respective tube until a dead stop of the first sub-element comes into contact with the second tube and a dead stop of the second sub-element comes into contact with the first tube, wherein the connecting element is joined, in particular welded, to the first and second tube at least at these contact points.

The connecting element, in particular a first sub-element of the connecting element, can be placed onto the one tube and can be rotated in the direction of the second tube until contact is made with the second tube. After the first sub-element has been placed, the second sub-element is likewise positioned onto the opposite second tube and is rotated until contact is made with the first tube. In this case, the sub-elements can be inserted into each other or inserted offset from each other as U-shells.

Further objectives, advantages, features, and applications of the present invention are derived from the subsequent description of an exemplary embodiment by way of the drawings. All described and/or depicted features, per se or in any combination, constitute the subject-matter of the present invention, regardless of their summary in the patent claims or their back-reference.

### DESCRIPTION OF THE DRAWINGS

Partially schematically, the drawings show:

FIG. 1 a perspective illustration of a connecting element,

FIG. 2 a perspective illustration of a sub-element of the connecting element according to FIG. 1,

FIG. 3 a perspective illustration of a further sub-element of the connecting element according to FIG. 1,

FIG. 4 a perspective illustration of a further embodiment of the connecting element, and in

FIG. 5 a perspective illustration of a crossmember with tubes and connecting element according to FIG. 1.

Identical or identically functioning components are provided with reference numerals based on an embodiment in the subsequently depicted figures of the illustration in order to improve readability.

### DETAILED DESCRIPTION

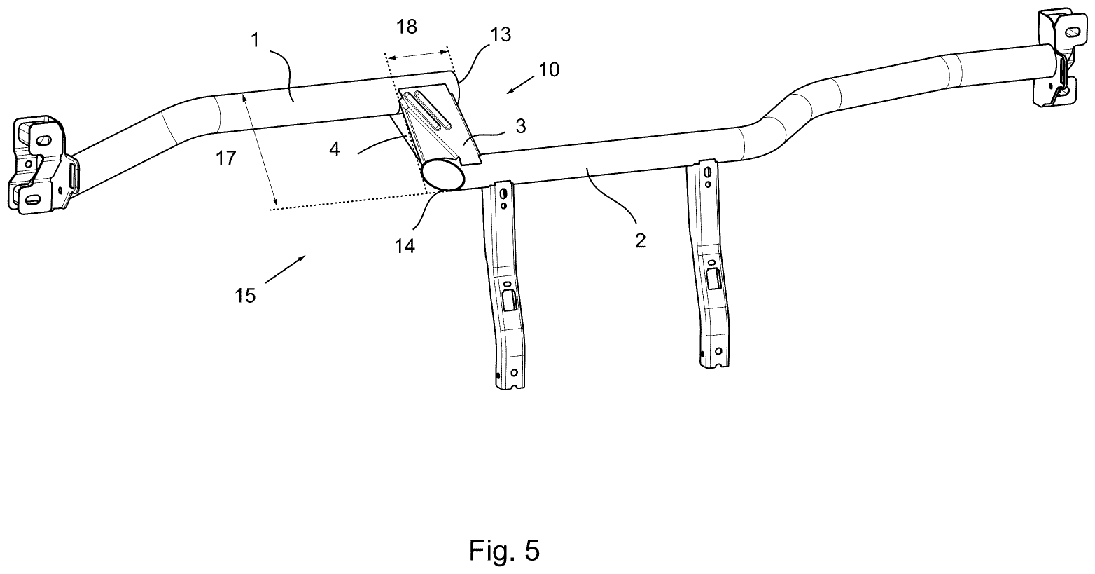

FIG. 5 shows a crossmember 15 for a motor vehicle. Such a crossmember 15 can be arranged as part of a motor vehicle body between the so-called A-pillars of the motor vehicle in the area below the windshield, extending approximately horizontally. The present crossmember 15 is generally used to fasten an instrument panel, wherein the crossmember 15 also stiffens the instrument panel. In addition to stiffening the instrument panel, the crossmember 15 must have a high bending stiffness due to its function as a chassis component, which also contributes toward increased safety of the motor vehicle and toward protecting the vehicle occupants in the event of an accident.

If the crossmember 15, as further shown in FIG. 5, has a tube arrangement assembled from several tubes 1, 2, this presents a basic problem of creating a bending-resistant joint between the individual tubes 1, 2. The connecting element 10 according to the invention is provided to realize such a bending-resistant joint.

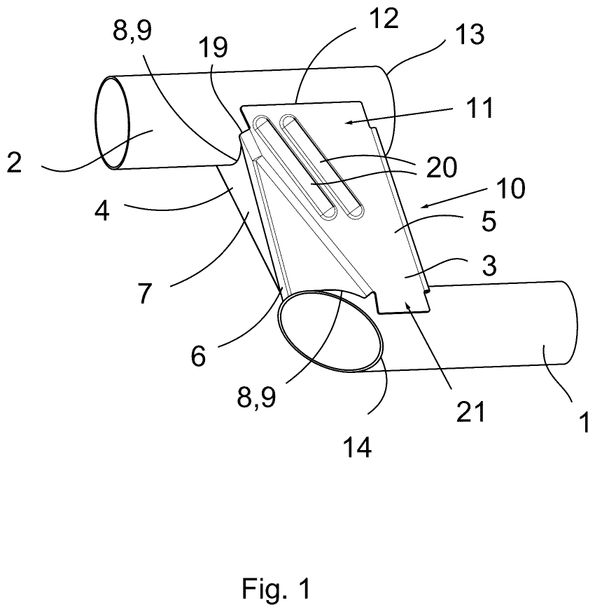

FIG. 1 shows the connecting element 10 for joining the first tube 1 to the second tube 2 of the crossmember 15 for a vehicle. In the present case, the connecting element 10 is substantially made of metal or plastic.

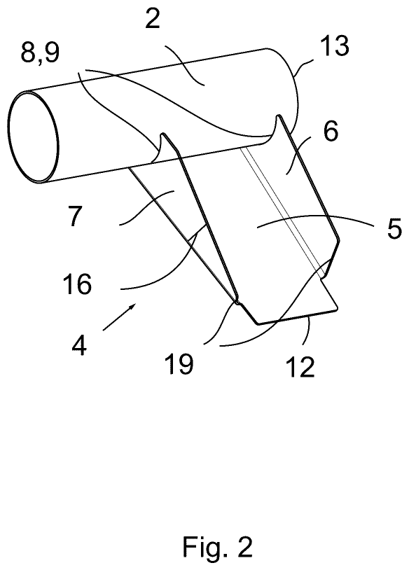

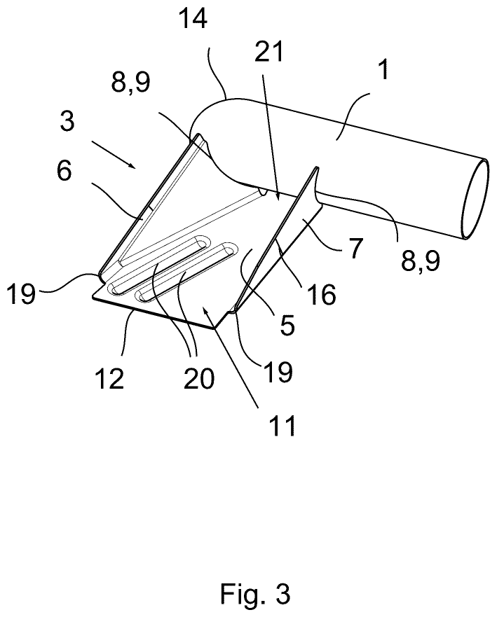

FIGS. 2 and 3 each show one of the tubes 1, 2 with one sub-element 3, 4 of

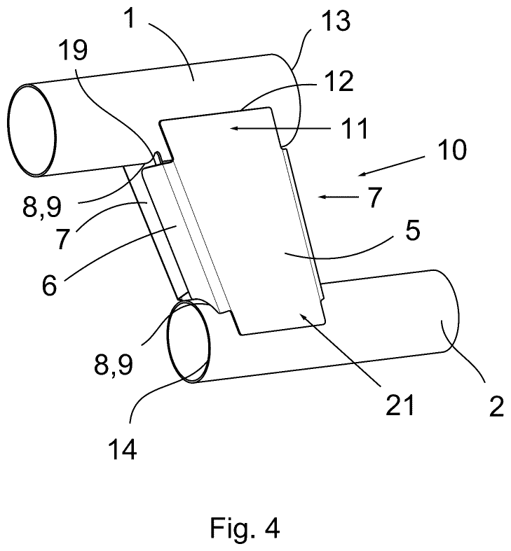

the connecting element 10, which is divided into two parts in the present embodiments. FIG. 4 shows a second embodiment of the connecting element 10.

In the sense of the present invention, the term “tube” is to be understood generically, i.e., the tube can have any cross-sectional shape that can be round, angular, or oval, for example. Furthermore, it goes without saying that as it relates to the inventive crossmember 15, the first tube 1 and the second tube 2 can have the same or different cross-sectional shapes and/or cross-sectional sizes.

Furthermore, as likewise shown in FIG. 5, the first tube 1 and/or the second tube 2 can not only have a straight projection, as seen in the longitudinal direction, but can also have one or more bends. In addition, the tubes 1, 2 can in the area of their joint not only extend parallel to each other but can also extend at an angle in relation to each other.

FIGS. 1 and 4, but also the illustrations shown in FIGS. 2 and 3, further show that each end face, i.e., the section of the connecting element 10 encompassing the tube 1, 2, is arranged, in particular, welded, on a single tube 1, 2, and not on both tubes 1, 2, as in the prior art. As a result, each part of the connecting element 10 can first be positioned on one of the tubes 1, 2 and then be brought into contact by rotating it until it makes contact to the opposite tube 1, 2.

Manufacturing tolerances can be compensated due to the arrangement of the first and second end face in the transverse direction of the tubes 1, 2 because the tubes 1, 2 are not brought into a constrained position, which would prevent tolerance compensation.

According to FIG. 1, the connecting element 10 comprises a longitudinal wall 5 adjoined in the present case by transverse walls 6, 7 arranged approximately perpendicular to the longitudinal wall 5. The longitudinal wall 5 is arranged between the first 6 and the second transverse wall 7 spaced apart from the first. In the assembled position of the connecting element 10, the longitudinal wall 5 extends from the first tube 1 to the second tube 2 and can be joined, in particular welded, to both tubes 1, 2. The first end 9 of the transverse wall 6, 7 is arranged opposite the first end 11 of the longitudinal wall 5 on the connecting element 10, i.e., at a second end 21 of the longitudinal wall 5.

At a first end 9, the transverse walls 6, 7 have an edge or edge region 8, which in the present case is adapted to the circumferential contour of the first tube 1, wherein said edge or edge region 8-for a rotationally movable arrangement of the connecting element 10-at least partially circumferentially abuts the outer circumference of the first tube 1.

As can be seen further in FIGS. 1 to 4, a section 12 is provided at a first end 11 of the longitudinal wall 5, which can be joined, in particular, welded, to the second tube 2 in the assembled position of the connecting element 10.

Both sub-elements 3, 4 each have the described longitudinal wall 5 and the transverse walls 6, 7. On one of the sub-elements 3, the transverse walls 6, 7 are adapted to the circumferential contour of the first tube 1; in the further sub-element 4, the transverse walls 6, 7 are adapted to the circumferential contour of the second tube 2. In the sense of the invention, it is understood that the transverse walls 6, 7 of the sub-element 3 can alternatively be adapted to the circumferential contour of the second tube 2 instead of to the circumferential contour of the first tube 1. The same also applies to sub-element 4. The labeling of the tubes as the first 1 and the second 2 tube is only an example.

At the first end 11 of the longitudinal wall 5, the connecting element 10 can therefore only be joined to the one tube 1, 2 by the connecting section 12 and can only be joined to the other tube 1, 2 at the second end 21 of the longitudinal wall 5 with a section and to at least one transverse wall 6, 7.

In the present case, the transverse walls 6, 7 and the longitudinal wall 5 are joined, in particular welded, with a substance-to-substance bond. It can also be provided that the transverse walls 6, 7 are formed integrally with the longitudinal wall 5.

FIGS. 1, 2, 3, and 5 show an embodiment of the connecting element 10, wherein the width 16 of the transverse wall 6, 7 is reduced to the second end 19 of the transverse wall 6, 7 opposite to the edge 8; in particular, the width 16 tapers toward this end 19.

Conversely, FIG. 4 shows a second embodiment of the connecting element 10, wherein the width of the transverse walls 6, 7 remains approximately the same in large areas of the transverse walls 6, 7, i.e., the latter does not taper toward one end. As with the first embodiment of the connecting element 10, an edge or edge area 8 of the transverse walls 6, 7 can also in the second variant be adapted to the circumferential contour of the tube 1, 2.

In particular the transverse walls 6, 7 of the first sub-element 3 have the edge or edge region 8 adapted to the circumferential contour of the first tube 1 and the transverse walls 6, 7 of the second sub-element 4 have the edge or edge region 8 adapted to the circumferential contour of the second tube 2, wherein the edges or edge regions 8—for the rotationally movable arrangement of the connecting element 10—at least partially circumferentially abut the outer circumference of the first 1 or second tube 2.

As mentioned, the spacing of the tubes 1, 2 fluctuates in the tolerance range. In order to keep both tubes 1, 2 in position despite the manufacturing tolerance, the connecting element 10 is adapted such that it can absorb this fluctuation without placing the two tubes 1, 2 in a constrained position. For this reason, the end face, i.e., the section of the connecting element 10 encompassing the tube 1, 2, is arranged on a single tube 1, 2, in particular welded thereto.

FIGS. 1 to 4 further show that the connecting element 10 comprises two sub-elements 3, 4, each of which in the present exemplary embodiment comprises a longitudinal wall 5 and two transverse walls 6, 7. In the present exemplary embodiment, the longitudinal wall 5 of each sub-element 3, 4 is arranged between the first 6 and a second transverse wall 7 spaced apart from the first.

The first end 11 of the longitudinal wall 5 of the first sub-element 3 can in the assembled position of the connecting element 10 be joined, in particular, welded, to the second tube 2, and the first end 11 of the longitudinal wall 5 of the first sub-element 4 can in the assembled position of the connecting element 10 be joined, in particular welded, to the first tube 1.

FIGS. 1 to 4 further show that the longitudinal wall 5 comprises a section 12 for joining to at least one tube 1, 2, wherein the connection section 12 projects at least on one side opposite the transverse wall 6, 7 of the sub-element 3, 4 and is adapted as a dead stop by which the sub-element 3, 4 comes to rest in the assembled position on one of the tubes 1, 2.

FIG. 5 shows the crossmember 15 for a vehicle with the first tube 1 and the second tube 2 and with a connecting element 10 described above for joining the first tube 1 to the second tube 2.

This FIG. 5 also shows the sub-elements 3, 4, which are joined, in particular, welded, together. A transverse wall 6, 7 of the sub-elements 3, 4 is joined, in particular, welded, to the tubes 1, 2.

In the assembled position, the longitudinal wall 5 and two transverse walls 6, 7 of the two sub-elements 3, 4 of the connecting element 10 form the shape of a polygonal profile in a sectional plane spanned between the two tubes 1, 2 and parallel to the longitudinal direction of the tubes 1, 2.

The respective transverse walls 6, 7 of the two sub-elements 3, 4 are in the assembled position engaged into each other or arranged at on offset in relation to each other, as FIGS. 1 to 4 further show. In addition, the transverse walls 6, 7 of the respective sub-elements 3, 4 can be joined, in particular, welded, to one another in the area where the sub-elements 3, 4 are arranged inside one another or in the area where the two sub-elements 3, 4 are arranged at an offset.

The first and second sub-element 3, 4 of the connecting element 10 is joined,

in particular welded, to the first tube 1 as well as to the second tube 2 with a substance-to-substance bond.

FIG. 5 further shows that the first tube 1 and the second tube 2 are arranged relative to one another with an offset 17 transverse to the longitudinal direction of the tubes 1, 2 and in the longitudinal direction of the tubes 1, 2 with an overlap region 18 extending over a partial length of the first tube 1 and over a partial length of the second tube 2 such that a first end 13 of the first tube 1 is arranged next to the second tube 2 and a second end 14 of the second tube 2 is arranged next to the first tube 1.

In order to join the two tubes 1, 2 of the crossmember 15 of the vehicle to one another, the aforementioned connecting element 10 is placed rotationally movable onto the first tube 1 and is rotated about the first tube 1 until a dead stop 12 of the connecting element 10 comes to rest on the second tube 2 and the connecting element 10 is permanently joined, in particular welded, to the second tube 1, 2 at least in the region of the dead stop 12. The connecting element 10 can of course also first be placed onto the second tube 2 and rotated about the second tube 2 until the dead stop 12 comes to rest on the first tube 1.

It can be provided that the connecting element 10 is permanently joined, in particular, welded, to the first tube 1 after it comes to rest on the second tube 2 with the dead stop 12.

As mentioned, the connecting element 10 in the present case comprises the two sub-elements 3, 4, wherein the first sub-element 3 is placed rotationally movable onto the first tube 1 and the second sub-element 4 is placed rotationally movable onto the second tube 2 and is rotated relative to the respective tube 1, 2 until the dead stop 12 of the first sub-element 3 comes into contact with the second tube 2 and the dead stop 12 of the second sub-element 4 comes into contact with the first tube 1. The connecting element 10 can then be joined, in particular, welded, to the first 1 and second tube 2 at least at these contact points.

FIGS. 1 and 3 further show that at least one of the sub-elements, in the present case the sub-element marked with the reference symbol 3, has a geometric feature in the form of two creases 20. These features further increase the bending stiffness, in particular the transverse wall stiffening of the connecting element 10. The position, the geometric design, and the number of creases are strictly intended as examples in the exemplary embodiment selected here. In the sense of the invention, numerous further variants are conceivable for increasing the bending stiffness.

### REFERENCE NUMERALS

1 Tube
2 Tube
3 First sub-element
4 Second sub-element
5 Longitudinal wall
6 Transverse wall
7 Transverse wall
8 Edge
9 First end of transverse wall
10 Connecting element
11 First end of longitudinal wall
12 Section/dead stop
13 First end of tube
14 Second end of tube
15 Crossmember
16 Width of the transverse wall
17 Offset
18 Overlap area
19 Second end of transverse wall
20 Creases
21 Second end of longitudinal wall

1. A connecting element (10) for joining a first tube (1) to a second tube (2) of a crossmember (15) for a vehicle, comprising: at least one longitudinal wall (5) adjoined by at least one transverse wall (6, 7), wherein the at least one transverse wall (6, 7) at a first end (9) has an edge (8) adapted to a circumferential contour of an outer circumference of the first tube (1), and said edge (8) at least partially circumferentially abuts the outer circumference of the first tube (1), and wherein a first end (11) of the longitudinal wall (5) has a section (12) configured to be joined to the second tube (2) to establish an assembled position of the connecting element (10).

2. The connecting element (10) according to claim 1, wherein the longitudinal wall (5) extends from the first tube (1) to the second tube (2) in the assembled position of the connecting element (10) and is to both tubes (1, 2).

3. The connecting element (10) according to claim 1, wherein the at least one transverse wall (6, 7) and the longitudinal wall (5) are either joined to one another or the at least one transverse wall (6, 7) is formed integrally with the longitudinal wall (5).

4. The connecting element (10) according to claim 1, wherein the longitudinal wall (5) is arranged between the first transverse wall (6) and a second transverse wall (7) that is spaced apart from the first transverse wall (6).

5. The connecting element (10) according to claim 1, wherein the transverse wall (6, 7) defines a width (16) and a second end (19), and the width (16) of the transverse wall (6, 7) decreases or tapers toward the second end (19) of the transverse wall (6, 7) opposite to the edge (8).

6. The connecting element (10) according to claim 1, wherein the longitudinal wall (5) at the first end (11) is configured to be respectively joined to one of the first tube or second tube (1, 2) and at a second end (21) opposite to the first end (11), and wherein the connecting element (10) is configured to be joined with at least one transverse wall (6, 7) to one of the first tube or second tube tubes (1, 2) at or near a second end (21) of the longitudinal wall (5).

7. The connecting element (10) according to claim 1, further comprising two sub-elements (3, 4), each of which comprises a longitudinal wall (5) and at least one transverse wall (6, 7), and the longitudinal wall (5) of each sub-element (3, 4) is arranged between the first transverse wall (6) and a second transverse wall (7) spaced apart from the first transverse wall (6).

8. The connecting element (10) according to claim 7, wherein the at least one transverse wall (6, 7) of the first sub-element (3) has the edge (8) or an edge region adapted to the circumferential contour of the first tube (1), and wherein the at least one transverse wall (6, 7) of the second sub-element (4) has the edge (8) or an edge region adapted to the circumferential contour of the first tube (1), wherein the edges (8) or edge regions at least partially circumferentially abut the outer circumference of the first or second tube (1), and the connecting element (1) is rotationally movable with respect to the first tube (1).

9. The connecting element (10) according to claim 7, wherein the first end (11) of the longitudinal wall (5) of the first sub-element (3) is configured to be joined to the second tube (2) in an assembled position of the connecting element (10), and wherein the first end (11) of the longitudinal wall (5) of the second sub-element (4) is configured to to the first tube (2) in the assembled position of the connecting element (10).

10. The connecting element (10) according to claim 1, wherein the longitudinal wall (5) comprises at least one section (12) for joining to at least one tube (1, 2), and wherein the connecting section (12) projects at least on one side opposite the at least one transverse wall (6, 7) of the sub-element (3, 4) and is adapted as a dead stop by which the sub-element (3, 4) comes to rest against one of the tubes (1, 2) with the connecting element (10) in an assembled position.

11. (canceled)

12. The connecting element (10) according to claim 7, wherein at least one of the sub-elements (3, 4) has at least one geometric feature (20) for increasing the bending stiffness of the connecting element (10), and wherein the at least one geometric feature (20) is formed as a crease.

13. A crossmember (15) for a vehicle having at least a first tube (1) and a second tube (2), comprising: a connecting element (10) for joining the first tube (1) to the second tube (2) according to claim 1.

14. The crossmember (15) according to claim 13, wherein the connecting element (10) comprises sub-elements (3, 4) that are joined to one another, and wherein at least one transverse wall (6, 7) of the sub-elements (3, 4) is joined with or joined to the tubes (1, 2).

15. The crossmember (15) according to claim 13, wherein, with the connecting element (10) in the assembled position, the longitudinal wall (5) and the two transverse walls (6, 7) of the two sub-elements (3, 4) of the connecting element (10) form the shape of a polygonal profile, in a sectional plane spanning between the two tubes (1, 2) and parallel to the longitudinal direction of the tubes (1, 2).

16. The crossmember (15) according to claim 14, wherein the respective transverse walls (6, 7) of the two sub-elements (3, 4) when in an assembled position are arranged inside each other or offset from one another, and wherein the transverse walls (6, 7) are at least partially joined to one another in the assembled position.

17. The crossmember (15) according to claim 14, wherein the first and second sub-elements (3, 4) of the connecting element (10) are joined to the first tube (1) and also are joined to the second tube (2) with a substance-to-substance bond.

18. The crossmember (15) according to claim 13, wherein the first tube (1) and the second tube (2) are arranged relative to one another with an offset (17) transverse to the longitudinal direction of the tubes (1, 2), and in the longitudinal direction of the tubes (1, 2) are arranged with an overlap region (18) extending over a partial length of the first tube (1) and over a partial length of the second tube (2) such that a first end (13) of the first tube (1) is arranged next to the second tube (2) and a second end (14) of the second tube (2) is arranged next to the first tube (1).

19. A method for joining two tubes (1, 2) of a crossmember (15) for a vehicle, comprising placing a connecting element (10) according to claim 1 rotationally movably onto the first tube (1) of the crossmember (15) and rotating the connecting element (10) about the first tube (1) until a dead stop (12) of the connecting element (10) comes to rest on the second tube (2) of the crossmember (15), and permanently joining the connecting element (10) to the second tube (2) at least in the region of the dead stop (12).

20. The method according to claim 19, wherein the connecting element (10) is permanently joined to the first tube (1) after it comes to rest on the second tube (2) with the dead stop (12).

21. The method according to claim 19, wherein the connecting element (10) comprises two sub-elements (3, 4), and wherein the first sub-element (3) is rotationally movable placed onto the first tube (1) and the second sub-element (4) is rotationally movable placed onto the second tube (2), and wherein the first sub-element (3) and the second sub-element (4) are rotated in relation to the respective tube (1, 2) until a dead stop (12) of the first sub-element (3) comes into contact with the second tube (2) and a dead stop (12) of the second sub-element (4) comes into contact with the first tube (1), and wherein the connecting element (10) is joined to the first tube (1) and the second tube (2) at least at these contact points.
